(19) United States
(12) Patent Application Publication
(10) Pub. No.: US 2014/0355198 A1
(43) Pub. Date: Dec. 4, 2014

(54) ELECTRONIC DEVICE

(71) Applicants: Hon Hai Precision Industry Co., Ltd., New Taipei (TW); Hong Fu Jin Precision Industry (ShenZhen) Co., Ltd., Shenzhen (CN)

(72) Inventors: WEI-KUANG LIANG, New Taipei (TW); QUAN-GUANG DU, Shenzhen (CN); CHUN TANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/181,629

(22) Filed: Feb. 15, 2014

(30) Foreign Application Priority Data
Jun. 4, 2013 (CN) 2013102182090

(51) Int. Cl. G06F 1/16

(52) U.S. Cl. CPC G06F 1/16
USPC 361/679.31

(57) ABSTRACT

An electronic device includes a case, a mounting member, and a storage device. The case includes a base and a cover covering the base. The base includes a securing portion. The cover includes a mounting portion. The storage device includes a retaining tab. The retaining tab is sandwiched between the mounting portion and the securing portion, and the mounting member is engaged with the mounting portion, the retaining tab and the securing portion, to secure the storage device to the case.

### FIELD

The present disclosure relates to electronic devices, and particularly to an electronic device with a storage device.

### BACKGROUND

Many personal computers include data storage devices such as optical disk drives (ODDs) and floppy disk drives. The data storage devices are attached to a chassis of a computer enclosure with a mounting tray. The mounting tray comprises a first mounting panel and a second mounting panel. The first mounting panel is secured to the storage device using screws, and the second mounting panel is secured to the chassis using screws. It is inconvenient and time consuming to use so many screws.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an electronic device in accordance with an embodiment.

FIG. 2 is similar to FIG. 1, but viewed from a different aspect.

FIG. 3 is an assembled view of the electronic device of FIG. 1.

FIG. 4 is a cross-sectional view of FIG. 3, taken along a line IV-IV.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

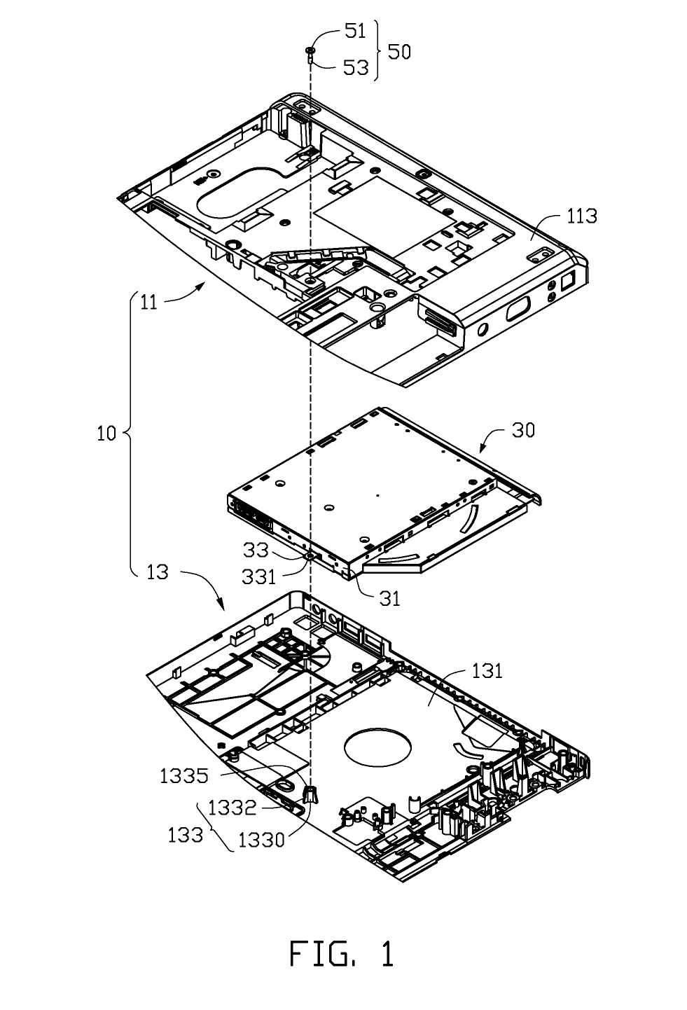

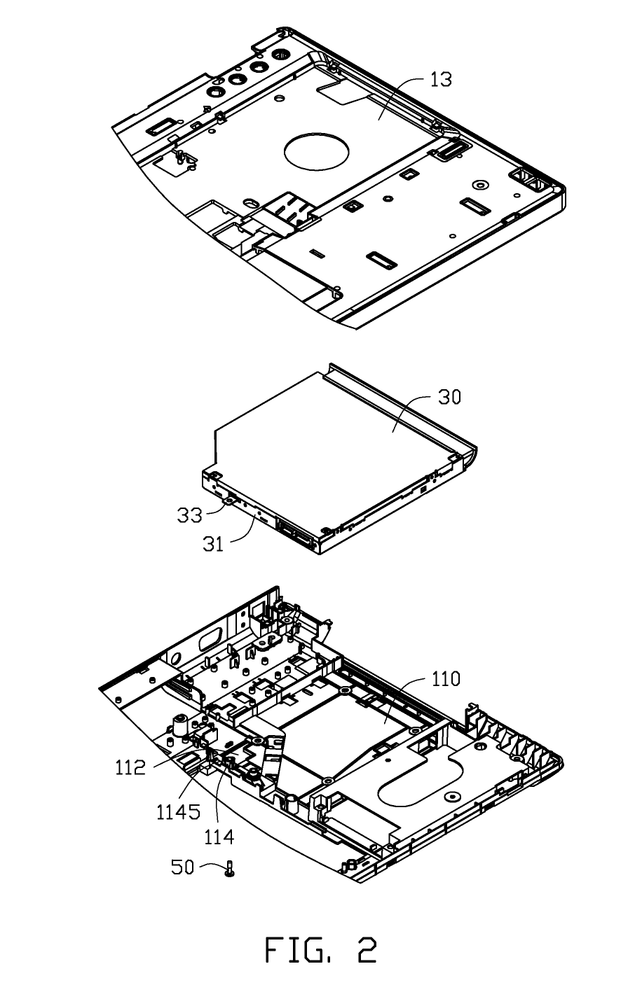

FIGS. 1-4 illustrate an electronic device in accordance with an embodiment. The electronic device comprises a case 10, a storage device 30 secured to the case 10, and a mounting member 50. In the illustrated embodiment, the storage device 30 is an optical disk drive as an example, however, the storage device 30 may be other drives, such as hard disk drives.

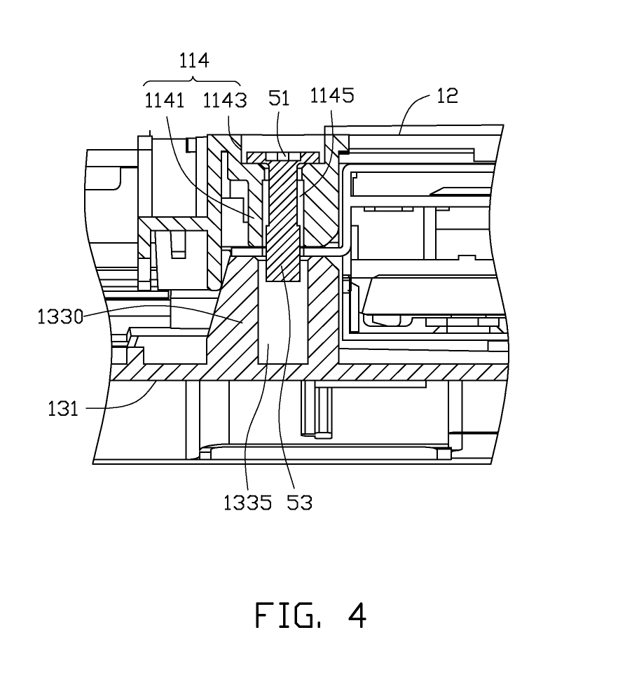

The case 10 comprises a base 11 and a cover 13 engaged with the base 11. The base 11 defines a receiving area 110 for receiving the storage device 30. The base 11 comprises an inner surface 112, an outer surface 113, and a securing portion 114. The securing portion 114 is adjacent to the receiving area 110 and comprises a securing post 1141 and a receiving portion 1143 connected to the securing post 1141 (see FIG. 4). In one embodiment, the securing post 1141 perpendicularly extends from the inner surface 112, and the receiving portion 1143 extends from the outer surface 113. A securing hole 1145 is defined in the securing portion 114 and extends through the securing post 1141 and the receiving portion 1143.

The cover 13 comprises a bottom surface 131 and a mounting portion 133. The mounting portion 133 comprises a mounting post 1330 and a plurality of strengthening ribs 1332 extending from the mounting post 1330. In one embodiment, the mounting post 1330 is substantially perpendicularly connected to the bottom surface 131. Each strengthening rib 1332 is slanted from the mounting post 1330. A mounting hole 1335 is defined in the mounting portion 133 and corresponds to the securing hole 1145.

The storage device 30 comprises a side panel 31 and a retaining tab 33 extending from the side panel 31. The retaining tab 33 is substantially perpendicular to the side panel 31. A through hole 331 is defined in the retaining tab 33.

The mounting member 50 comprises a head 51 and a fixing portion 53 connected to the head 51. In one embodiment, a cross-section of the head 51 is round, and a diameter of the head 51 is greater than a diameter of the fixing portion. In one embodiment, the mounting member 50 is a screw.

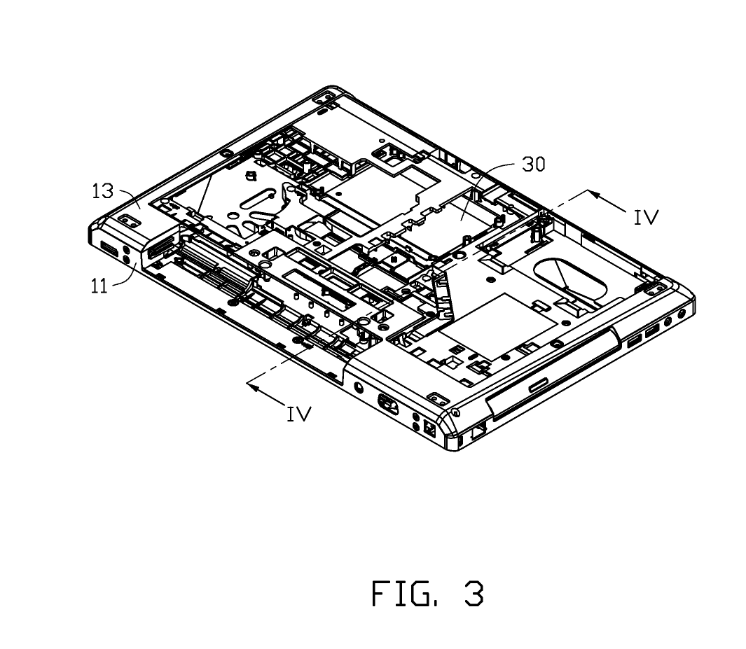

Further referring to FIGS. 3-4, FIGS. 3-4 illustrate that in assembly, the storage device 30 is placed in the receiving area 110, and the retaining tab 33 is placed on the securing portion 1141. The cover 13 is covering the base 11, and the mounting portion 133 abuts the retaining tab 33. The securing hole 1145 is aligned with the through hole 331 and the mounting hole 1335. The mounting member 50 is engaged in the securing hole 1145, the through hole 331, and the mounting hole 1335, to secure the storage device 30 to the case 10. The retaining tab 33 is sandwiched between the securing portion 114 and the mounting portion 133.

In disassembly, the mounting member 50 is disengaged from the securing hole 1145, the through hole 331, and the mounting hole 1335. The retaining tab 33 is removed from the securing portion 114 and the mounting portion 133, and the storage device 30 can be disengaged from the case 10.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. An electronic device comprising:
a case comprising a base and a cover engaged with the base; the base comprising a securing portion; the cover comprising a mounting portion;
a mounting member; and
a storage device comprising a retaining tab;
wherein the retaining tab is sandwiched between the mounting portion and the securing portion, and the mounting member is engaged with the mounting portion, the retaining tab and the securing portion, to secure the storage device to the case.

2. The electronic device of claim 1, wherein the storage device further comprises a side panel, and the retaining tab perpendicularly extends from the side panel.

3. The electronic device of claim 1, wherein the base further comprises an inner surface, and the securing portion further comprises a securing post perpendicularly extending from the inner surface.

4. The electronic device of claim 3, wherein the base further comprises an outer surface opposite to the inner surface, the securing portion further comprises a receiving portion, and the receiving portion is connected to the securing post.

5. The electronic device of claim 4, wherein the securing portion defines a securing hole extending through the securing post and the receiving portion, the retaining tab defines a through hole, the mounting portion defines a mounting hole, and the mounting member is engaged in the securing hole, the through hole and the mounting hole.

6. The electronic device of claim 5, wherein the mounting member further comprises a head and a fixing portion connected to the head, the head is received in the receiving portion, and the fixing portion is received in the securing hole, the through hole and the mounting hole.

7. The electronic device of claim 5, wherein the cover further comprises a bottom surface, and the mounting portion further comprises a mounting post perpendicularly extending from the bottom surface, and the mounting hole is defined in the mounting post.

8. The electronic device of claim 7, wherein the mounting portion further comprises a strengthening rib, and the strengthening rib is slanted from the mounting post and connected to the bottom surface.

9. An electronic device comprising:
a case comprising a base and a cover engaged with the base; the base comprising a securing portion, and the securing portion defining a securing hole; the cover comprising a mounting portion, and the mounting portion defining a mounting hole;
a mounting member; and
a storage device comprising a retaining tab; and the retaining tab defining a through hole;
wherein the retaining tab is sandwiched between the mounting portion and the securing portion, and the mounting member is engaged in the securing hole, the through hole and the mounting hole, to secure the storage device to the case.

10. The electronic device of claim 9, wherein the storage device further comprises a side panel, and the retaining tab perpendicularly extends from the side panel.

11. The electronic device of claim 9, wherein the base further comprises an inner surface, and the securing portion further comprises a securing post perpendicularly extending from the inner surface.

12. The electronic device of claim 11, wherein the base further comprises an outer surface opposite to the inner surface, the securing portion further comprises a receiving portion, and the receiving portion is connected to the securing post.

13. The electronic device of claim 9, wherein the securing hole extends through the securing post and the receiving portion

14. The electronic device of claim 9, wherein the mounting member further comprises a head and a fixing portion connected to the head, the head is received in the receiving portion, and the fixing portion is received in the securing hole, the through hole and the mounting hole.

15. The electronic device of claim 9, wherein the cover further comprises a bottom surface, and the mounting portion further comprises a mounting post perpendicularly extending from the bottom surface, and the mounting hole is defined in the mounting post.

16. The electronic device of claim 15, wherein the mounting portion further comprises a strengthening rib, and the strengthening rib is slanted from the mounting post and connected to the bottom surface.
